(19) United States
(12) Patent Application Publication
(10) Pub. No.: US 2023/0050406 A1
(43) Pub. Date: Feb. 16, 2023

(54) FILM AND WATER STOPPING TAPE

(71) Applicant: FUJIFILM CORPORATION, Tokyo (JP)

(72) Inventors: Haruki TOMIKAWA, Kanagawa (JP); Toshihide YOSHITANI, Kanagawa (JP); Kyohisa UCHIUMI, Kanagawa (JP); Ren ISHIKAWA, Kanagawa (JP)

(21) Appl. No.: 17/815,933

(22) Filed: Jul. 28, 2022

(30) Foreign Application Priority Data
Jul. 30, 2021 (JP) 2021-126169

(51) Int. Cl. C09J 7/29; B32B 5/02; B32B 27/36; B32B 27/12; B32B 7/12

(52) U.S. Cl. CPC C09J 7/29; B32B 5/022; B32B 27/36; B32B 27/12; B32B 7/12; C09J 2301/41; C09J 2475/006; B32B 2255/02; B32B 2255/26; B32B 2405/00; B32B 2307/726

(57) ABSTRACT

Provided is a film and a water stopping tape that realize long-lasting water stopping properties. The film includes an outermost layer containing a water-absorbent polymer having a water absorbency of 5 g/g to 100 g/g that is represented by a ratio of a mass of a sample having been immersed in water for 3 hours to a mass of the sample not yet being immersed in water a permeable layer, and a substrate layer in this order, and the water stopping tape includes the film.

### CROSS-REFERENCE TO RELATED APPLICATION

The present application claims priority under 35 U.S.C. § 119 to Japanese Patent Application No. 2021-126169, filed Jul. 30, 2021. The above application is hereby expressly incorporated by reference, in its entirety, into the present application.

### BACKGROUND OF THE INVENTION

### 1. Field of the Invention

The present disclosure relates to a film and a water stopping tape.

### 2. Description of the Related Art

Polymers having properties of absorbing water are used in various articles such as a waterproof sheet. As applications of polymers having properties of absorbing water, the following techniques are known.

For example, JP2009-084840A discloses a waterproof sheet for construction groundworks. In the waterproof sheet for construction groundworks, a nonwoven fabric having a swelling layer consisting of a water-absorbent polymer resin is interposed between two layers of synthetic resin films. In the swelling layer, a water-absorbent polymer resin that swells more than 200 times by absorbing water is used.

For example, JP1991-058953U (JP-H03-058953U) discloses an excretion treatment material for laboratory animals. In the excretion treatment material for laboratory animals, an absorbent sheet is used which consists of two sheets of absorbent paper and a super water-absorbent resin capable of absorbing water not less than 50 times the weight of the resin. The super water-absorbent resin is held between the two sheets of absorbent paper.

### SUMMARY OF THE INVENTION

As an application of polymers having properties of absorbing water, a water stopping technique is being studied. Examples of the water stopping technique include a technique of stopping water entering a building through gaps of objects such as windows and doors. The above technique is considered to be useful, for example, as a flood control measure.

In JP2009-084840A, water stopping properties for nail holes formed in a waterproof sheet for construction groundworks are emphasized. The water that has entered from around the nail holes formed in the waterproof sheet for construction groundworks is absorbed into the water-absorbent polymer resin of the swelling layer, the water-absorbent polymer resin swells to stop up microvoids around the nail holes and prevents permeation of water. Incidentally, the swelling layer is interposed between two layers of synthetic resin films. Therefore, the swollen water-absorbent polymer resin can stop up the water permeating holes in the waterproof sheet for construction groundworks, but cannot stop up water permeating holes in objects other than the waterproof sheet for construction groundworks.

Furthermore, even though the excretion treatment material for laboratory animals disclosed in JP1991-058953U (JP-H03-058953U) is used for the water stopping technique, there is the possibility that excellent water stopping properties may not be obtained, and duration of the water stopping properties may be shortened. For example, in a case where the super water-absorbent resin absorbs a large amount of water, the absorbent sheet is likely to be peeled off due to the overexpansion of the super water-absorbent resin. These phenomena are likely to lead to shortening of the duration of water stopping properties.

An embodiment of the present disclosure aims to provide a film that realizes long-lasting water stopping properties. Another embodiment of the present disclosure aims to provide a water stopping tape that realizes long-lasting water stopping properties.

The present disclosure includes the following aspects.

<1> A film including an outermost layer containing a water-absorbent polymer having a water absorbency of 5 g/g to 100 g/g hat is represented by a ratio of a mass of a sample having been immersed in water for 3 hours to a mass of the sample not yet being immersed in water, a permeable layer, and a substrate layer in this order.

<2> The film described in <1>, in which the water-absorbent polymer includes a polyurethane.

<3> The film described in <2>, in which the polyurethane is a polyurethane obtained by reacting a polyalkylene oxide, a diol having a molecular weight of 500 or less, and a diisocyanate.

<4> The film described in <3>, in which the polyalkylene oxide is at least one kind of compound selected from the group consisting of polyethylene oxide and polypropylene oxide.

<5> The film described in <3> or <4>, in which the diol is 1,4-butanediol.

<6> The film described in any one of <3> to <5>, in which the diisocyanate is 4,4′-diphenylmethane diisocyanate.

<7> The film described in any one of <1> to <6>, in which the outermost layer contains a plasticizer.

<8> A water stopping tape containing the film described in any one of <1> to <7>.

According to an embodiment of the present disclosure, a film that realizes long-lasting water stopping properties is provided. According to another embodiment of the present disclosure, a water stopping tape that realizes long-lasting water stopping properties is provided.

### BRIEF DESCRIPTION OF THE DRAWINGS

FIG. 1 is a schematic plan view showing the configuration of a film according to an embodiment.

FIG. 2 is a cross-sectional view taken along the line A-A in FIG. 1.

FIG. 3 is a schematic cross-sectional view showing the configuration of a film according to another embodiment.

### DESCRIPTION OF THE PREFERRED EMBODIMENTS

Hereinafter, embodiments of the present disclosure will be specifically described. The present disclosure is not limited to the following embodiments. The following embodiments may be modified as appropriate within the intended scope of the present disclosure.

In a case where the embodiments of the present disclosure are described with reference to the drawings, sometimes the constituents and reference numerals overlapping in the drawings are not described. The constituents represented by the same reference numeral in the drawings are the same constituents. The dimensional ratio in the drawings does not necessarily represent the actual dimensional ratio. For convenience, sometimes a certain constituent is highlighted in the drawings.

In the present disclosure, a range of numerical values described using “to” means a range including the numerical values listed before and after “to” as the lower limit and the upper limit.

As for numerical ranges described stepwise in the present disclosure, the upper limit of a certain numerical range may be replaced with the upper limit of another numerical range described stepwise, and the lower limit of a certain numerical range may be replaced with the lower limit of another numerical range described stepwise. In addition, as for the numerical ranges described stepwise in the present disclosure, the upper or lower limit of a certain numerical range may be replaced with the values described in examples.

In the present disclosure, in a case where there is a plurality of substances in a composition that corresponds to each component of the composition, unless otherwise specified, the amount of each component in the composition means the total amount of the plurality of substances present in the composition.

In the present disclosure, a combination of preferable aspects is a more preferable aspect.

Film

Hereinafter, the film according to an aspect of the present disclosure will be described.

In an embodiment of the present disclosure, the film includes an outermost layer, a permeable layer, and a substrate layer in this order. Furthermore, the outermost layer contains a water-absorbent polymer having a water absorbency of 5 g/g to 100 g/g that is represented by a ratio of a mass of a sample having been immersed in water for 3 hours to a mass of the sample not yet being immersed in water. In the present disclosure, “water-absorbent polymer” means a polymer having a water absorbency of 5 g/g or more. Hereinafter, “water-absorbent polymer having a water absorbency of 5 g/g to 100 g/g” will be called “specific water-absorbent polymer” in some cases.

According to the embodiment described above, a film that realizes long-lasting water stopping properties is provided. Presumably, the long-lasting water stopping properties may be exhibited for the following reason. For example, in a case where the film is used in a method of preventing or reducing permeation of water into an object to protect such as a building, the film is disposed on a water permeating hole (for example, a gap) so that the outermost layer faces the water permeating hole. In a case where the outermost layer expands by absorbing water, the expanded outermost layer stops up the water permeating hole, which makes it possible to prevent or reduce the permeation of water. In a case where the specific water-absorbent polymer contained in the outermost layer has a water absorbency of 5 g/g or more, the expansion of the outermost layer resulting from water absorption is promoted, and the water stopping properties are improved. In contrast, in a case where the specific water-absorbent polymer contained in the outermost layer has a water absorbency of 100 g/g or less, the overexpansion of the outermost layer is prevented, and the water stopping properties last for a long time. Therefore, a film that realizes long-lasting water stopping properties is provided.

Outermost Layer

In an embodiment of the present disclosure, the film includes an outermost layer. The outermost layer is located on the outermost side in the laminated structure of the film. For example, in a case where the film is used in a water permeation-preventing or reducing method as a water stopping technique, the outermost layer can be placed to face a water permeating hole, and the outermost layer expanding by absorbing water can prevent or reduce permeation of water by stopping up the water permeating hole.

The outermost layer contains a water-absorbent polymer having a water absorbency of 5 g/g to 100 g/g that is represented by a ratio of a mass of a sample having been immersed in water for 3 hours to a mass of the sample not yet being immersed in water. That is, the outermost layer contains a specific water-absorbent polymer. In a case where the specific water-absorbent polymer contained in the outermost layer has a water absorbency of 5 g/g or more, the expansion of the outermost layer resulting from water absorption is promoted, and the water stopping properties are improved. From the viewpoint of improving water stopping properties, the water absorbency of the specific water-absorbent polymer is preferably 10 g/g or more, more preferably 15 g/g or more, and even more preferably 20 g/g or more. On the other hand, in a case where the water absorbency of the specific water-absorbent polymer contained in the outermost layer is 100 g/g or more, overexpansion of the outermost layer is prevented, and the water stopping properties last for a long time. From the viewpoint of improving long-lasting water stopping properties, the water absorbency of the specific water-absorbent polymer is preferably 80 g/g or less, more preferably 60 g/g or less, and even more preferably 40 g/g or less. The water absorbency may be adjusted by a known method. The water absorbency is adjusted, for example, by chemical structure and molecular weight. For example, in a case where the polyurethane obtained using a polyalkylene oxide is used as the specific water-absorbent polymer, increasing the proportion of the polyalkylene oxide (preferably at least one kind of compound selected from the group consisting of polyethylene oxide and polypropylene oxide) enhances the water absorbency. For example, increasing the ratio of polyethylene oxide to polypropylene oxide enhances the water absorbency. For instance, in a case where the polyurethane obtained using a diol is used as the specific water-absorbent polymer, increasing the proportion of the diol enhances the water absorbency.

In the present disclosure, “water absorbency” is represented by the ratio of a mass of a sample having been immersed in water for 3 hours to a mass of the sample not yet being immersed in water. The water absorbency is measured by a water immersion test. The specific procedure of the water immersion test is described below.

(1) A mixture obtained by adding 0.1 g of a sample to 200 mL of pure water is stirred. The temperature of the pure water is 25° C.

(2) After 3 hours of stirring, the mixture is filtered through a wire mesh having an opening size of 75 μm (for example, a mesh sieve manufactured by TOKYO SCREEN CO., LTD). Here, in a case where the sample (excluding the sample dissolved in pure water) passes through the wire mesh, a wire mesh having an opening size smaller than 75 μm may be used.

(3) Three minutes after the end of filtration, the mass (unit: g) of the sample remaining on the wire mesh is measured, and the obtained value is adopted as “mass of a sample having been immersed in water for 3 hours”.

(4) The ratio of the mass of a sample having been immersed in water for 3 hours to the mass (that is, 0.1 g) of the sample not yet being immersed in water is calculated, and the obtained value is adopted as “water absorbency”.

As long as the water absorbency is 5 g/g to 100 g/g, the type of specific water-absorbent polymer is not limited. From the viewpoint of improving water stopping properties and degree of freedom of structure design, the specific water-absorbent polymer preferably includes a polyurethane. The structure of the polyurethane can be designed with a high degree of freedom, and the water absorbency can be freely adjusted depending on the structure design. In addition, the film containing a polyurethane as the specific water-absorbent polymer can exhibit high water stopping properties even to water having a high salt concentration such as sea water. Furthermore, because most polyurethanes are soluble in a solvent and have thermoplasticity, the environmental load in the manufacturing process could be reduced.

From the viewpoint of improving water stopping properties and a degree of freedom of structure design, the polyurethane preferably includes a hard segment and a soft segment. The hard segment is a region that is relatively harder than the soft segment. The hard segment is formed, for example, by the reaction between a short-chain polyol (for example, a low-molecular-weight diol) and an isocyanate. Because the soft segment can carry water, increasing the proportion of the soft segment leads to the increase of water absorbency. The soft segment is formed, for example, by the reaction between a long-chain polyol (for example, a polyalkylene oxide) and an isocyanate.

The polyurethane may be selected from known polyurethanes having a water absorbency of 5 g/g to 100 g/g. Examples of the polyurethane include a polyurethane obtained by reacting an active hydrogen-containing compound with an isocyanate. Examples of preferable polyurethanes include a polyurethane obtained by reacting a polyalkylene oxide, a diol having a molecular weight of 500 or less, and a diisocyanate. The polyalkylene oxide and the diisocyanate contribute to the formation of the soft segment. The diol having a molecular weight of 500 or less and the diisocyanate contribute to the formation of the hard segment.

Examples of the active hydrogen-containing compound include a compound having a hydroxy group. Examples of the compound having a hydroxy group include a polyalkylene oxide and a low-molecular-weight diol. One kind of active hydrogen-containing compound or two or more kinds of active hydrogen-containing compounds may be used.

Examples of the polyalkylene oxide include polyethylene oxide and polypropylene oxide. The polyalkylene oxide preferably includes polyethylene oxide. The polyalkylene oxide is preferably at least one kind of compound selected from the group consisting of polyethylene oxide and polypropylene oxide, and more preferably polyethylene oxide. One kind of polyalkylene oxide or two or more kinds of polyalkylene oxides may be used. The polyalkylene oxide may be polyethylene oxide or polypropylene oxide.

In a case where polyethylene oxide and polypropylene oxide are used together, the ratio of the total mass of the polypropylene oxide to the total mass of the polyethylene oxide (that is, [total mass of polypropylene oxide]/[total mass of polyethylene oxide]) is preferably 0.10 to 0.35, more preferably 0.15 to 0.30, and even more preferably 0.15 to 0.25.

The weight-average molecular weight of the polyalkylene oxide is preferably 3,000 to 100,000, more preferably 3,000 to 80,000, and even more preferably 3,000 to 60,000.

The weight-average molecular weight of the polyethylene oxide is preferably 10,000 to 100,000, more preferably 20,000 to 80,000, and even more preferably 30,000 to 60,000.

The weight-average molecular weight of the polypropylene oxide is preferably 3,000 to 50,000, more preferably 3,000 to 30,000, and even more preferably 3,000 to 10,000.

In the present disclosure, the weight-average molecular weight is measured by gel permeation chromatography (GPC). The measurement conditions of gel permeation chromatography (GPC) are as follows. The calibration curve is plotted from 8 samples of “Standard sample TSK standard, polystyrene” manufactured by Tosoh Corporation: “F-40”, “F-20”, “F-4”, “F-1”, “A-5000”, “A-2500”, “A-1000”, and “n-propylbenzene”.

Measuring device: HLC (registered trademark)-8020GPC (manufactured by Tosoh Corporation)

Column: TSKgel (registered trademark) Super Multipore HZ-H (4.6 mm ID×15 cm, manufactured by Tosoh Corporation)×3

Eluent: tetrahydrofuran (THF), N-methylpyrrolidone (NMP), dimethylformamide (DMF), or water

Sample concentration: 0.45% by mass

Flow rate: 0.35 mL/min

Amount of sample injected: 10 μL

Measurement temperature: 40° C.

Detector: RI detector

Examples of the low-molecular-weight diol include a diol having a molecular weight of 500 or less. The lower limit of the molecular weight of the diol may be 62. Examples of the low-molecular-weight diol include ethylene glycol, diethylene glycol, triethylene glycol, tetraethylene glycol, propylene glycol, dipropylene glycol, trimethylene glycol, 1,3-butanediol, 2,3-butanediol, 1,4-butanediol, 1,5-pentanediol, hexylene glycol, octylene glycol, glyceryl monoacetate, glyceryl monobutyrate, 1,6-hexanediol, and 1,9-nonanediol. The low-molecular-weight diol is preferably 1,4-butanediol. One kind of low-molecular-weight diol or two or more kinds of low-molecular-weight diols may be used.

Examples of the isocyanate include a diisocyanate. Examples of the diisocyanate include an aliphatic diisocyanate and an aromatic diisocyanate. Specific examples of the diisocyanate include 4,4′-diphenylmethane diisocyanate, 1,6-hexamethylene diisocyanate, 1,8-dimethylbenzol-2,4-diisocyanate, 2,4-tolylene diisocyanate, and 2,2′-dimethyl-4,4′-diphenylmethane diisocyanate, 1,3-bis(isocyanatemethyl)benzene, 1,4-bis(isocyanatemethyl)benzene, 1,3-bis(isocyanatemethyl)cyclohexane, 1,4-bis(isocyanatemethyl)cyclohexane, 4,4′-dicyclohexylmethane diisocyanate, and isophorone diisocyanate. The diisocyanate is preferably 4,4′-diphenylmethane diisocyanate. One kind of isocyanate or two or more kinds of isocyanates may be used.

The polyurethane may be a commercially available product. Examples of the commercially available product include a super water-absorbent thermoplastic polyurethane elastomer manufactured by BASF SE (trade name: ELASTOLLAN BO38) and hydrophilic polyurethane (trade names: AQUACALK C, AQUACALK TWB, and AQUACALK TWB-P) manufactured by SUMITOMO SEIKA CHEMICALS CO., LTD.

Examples of the specific water-absorbent polymer include a (meth)acrylic polymer, a vinyl-based polymer, and polysaccharides.

“(Meth)acrylic polymer” means a polymer containing a constitutional unit derived from a monomer having a (meth)acryloyl group. The term “(meth)acryloyl group” includes an acryloyl group or a methacryloyl group or includes both the acryloyl group and methacryloyl group.

The (meth)acrylic polymer may be a homopolymer or a copolymer.

Examples of the monomer having a (meth)acryloyl group include a (meth)acrylic acid, a (meth)acrylamide, and a (meth)acrylic acid ester.

Examples of the (meth)acrylamide include acrylamide, methacrylamide, N-methylacrylamide, N,N′-dimethylacrylamide, N,N′-dimethylmethacrylamide, and N-methylolacrylamide.

The (meth)acrylic acid ester is preferably a (meth)acrylic acid alkyl ester, and more preferably a (meth)acrylic acid alkyl ester having 1 to 4 carbon atoms in the alkyl moiety. Examples of the (meth)acrylic acid alkyl ester include methyl (meth)acrylate, ethyl (meth)acrylate, butyl (meth)acrylate, and isobutyl (meth)acrylate.

Examples of the (meth)acrylic polymer include a polyacrylic acid, a polymethacrylic acid, a polyacrylate, a crosslinked polyacrylic acid, a crosslinked polyacrylate, an acrylic acid/acrylate copolymer, a polyacrylamide, polymethacrylamide, an acrylamide/acrylic acid copolymer, an acrylamide/methacrylic acid copolymer, an acrylamide/methyl acrylate copolymer, an acrylamide/methyl methacrylate copolymer, a N,N′-dimethylacrylamide/N-methylolacrylamide/methyl methacrylate copolymer, polymethyl (meth)acrylate, polyethyl (meth)acrylate, polybutyl (meth)acrylate, and polyisobutyl (meth)acrylate.

The weight-average molecular weight of the (meth)acrylic polymer is preferably 100,000 to 10,000,000, more preferably 250,000 to 5,000,000, and even more preferably 500,000 to 2,500,000. The weight-average molecular weight is measured by the method described above.

“Vinyl-based polymer” means a polymer containing a constitutional unit derived from a monomer having a vinyl group. The vinyl-based polymer may be a homopolymer or a copolymer.

Examples of the monomer having a vinyl group include vinyl acetate, vinylpyrrolidone, and vinyl methyl ether.

Examples of the vinyl-based polymer include polyvinyl alcohol, polyvinylpyrrolidone, polyvinylpolypyrrolidone, and polyvinyl methyl ether.

Examples of the polysaccharides include alginate, xanthan gum, gellan gum, gum tragacanth, karaya gum, gum arabic, carrageenan, dextrin, agar, pectin, pullulan, locust bean gum, sacran, tamarind seed gum, hydroxyethyl cellulose, hydroxypropyl cellulose, carboxymethyl cellulose, carboxymethyl ethyl cellulose, a hydroxypropyl cellulose salt, a carboxymethyl cellulose salt, a carboxymethyl ethyl cellulose salt, cellulose nanofibers (for example, Tempo-oxidized cellulose nanofibers, carboxymethylated cellulose nanofibers, phosphoesterified cellulose nanofibers, and mechanically defibrated cellulose nanofibers), chitosan nanofibers, cellulose microfibrils, hyaluronate, and hyaluronic acid.

It is preferable that the specific water-absorbent polymer contained in the outermost layer be crosslinked. The specific water-absorbent polymer crosslinked in advance may be used, or the specific water-absorbent polymer may be crosslinked in the process of forming the outermost layer.

The form of the specific water-absorbent polymer contained in the outermost layer is not limited. The specific water-absorbent polymer may be particles. The specific water-absorbent polymer may be in contact with the constituent (for example, fibers) of the permeable layer. For example, in a case where the permeable layer contains fibers, the specific water-absorbent polymer may cover at least some the fibers of the permeable layer.

The outermost layer may contain one kind of specific water-absorbent polymer or two or more kinds of specific water-absorbent polymers.

From the viewpoint of long-lasting water stopping properties, the ratio of the total mass of the specific water-absorbent polymer to the total mass of the outermost layer is preferably 10% by mass to 100% by mass, more preferably 30% by mass to 100% by mass, and even more preferably 50% by mass to 100% by mass. The ratio of the total mass of the specific water-absorbent polymer to the total mass of the outermost layer may be less than 100% by mass.

The outermost layer may further contain other components. Examples of those other components include a polymer other than the specific water-absorbent polymer, a plasticizer, and a pressure-sensitive adhesive component. Examples of those other components also include a component derived from a composition containing the specific water-absorbent polymer that will be described later.

The outermost layer preferably contains a plasticizer. The plasticizer improves the workability of the film.

Examples of the plasticizer include a polyester-based plasticizer, a polyether ester-based plasticizer, a polyvalent carboxylic acid ester-based plasticizer, a glycerin-based plasticizer, a phosphoric acid ester-based plasticizer, an epoxy-based plasticizer, and a polyacrylic acid ester-based plasticizer.

Examples of the polyester-based plasticizer include a polyester obtained by reacting an acid component (for example, adipic acid, sebacic acid, terephthalic acid, isophthalic acid, naphthalenedicarboxylic acid, or diphenyldicarboxylic acid) with a diol component (for example, propylene glycol and 1,3-butanediol, 1,4-butanediol, 1,6-hexanediol, ethylene glycol, or diethylene glycol). Examples of the polyester-based plasticizer include a polyester consisting of a hydroxycarboxylic acid (for example, polycaprolactone). The terminal of the polyester may be sealed with a monofunctional carboxylic acid or a monofunctional alcohol. The terminal of the polyester may be sealed with an epoxy compound. Examples of commercially available products thereof include ADEKACISER PN-150, PN-170, P-200, and PN-350 manufactured by ADEKA CORPORATION.

The polyether ester-based plasticizer is preferably an organic acid ester of polyalkylene glycol. Examples of the polyalkylene glycol include polyethylene glycol, polypropylene glycol, polybutylene glycol, a poly(ethylene oxide propylene oxide) block copolymer, a poly(ethylene oxide propylene oxide) random copolymer, and polytetramethylene glycol. Aromatic units such as bisphenols may be contained in the polyether chain. Examples of the organic acid include a monocarboxylic acid (for example, butanoic acid, isobutanoic acid, 2-ethylbutyric acid, 2-ethylhexanoic acid, and decanoic acid). Examples of commercially available products thereof include ADEKACIZER RS-1000, RS-735, and RS-700 manufactured by ADEKA CORPORATION.

Examples of the polyvalent carboxylic acid ester-based plasticizer include an aliphatic dicarboxylic acid ester, an aromatic dicarboxylic acid ester, a trimellitic acid ester, and a citric acid ester (for example, acetyl triethyl citrate and acetyl tributyl citrate).

Examples of the aliphatic dicarboxylic acid ester include an adipic acid ester (for example, diisodecyl adipate, di-n-octyl-adipate, and di-n-decyl adipate), an azelaic acid ester (for example, di-2-ethylhexyl azelate), and a sebacic acid ester (for example, dibutyl sebacate and di-2-ethylhexyl sebacate).

Examples of the aromatic dicarboxylic acid ester include a phthalic acid ester (for example, dimethyl phthalate, diethyl phthalate, dibutyl phthalate, dioctyl phthalate, diheptyl phthalate, dibenzyl phthalate, and butyl phthalate).

Examples of the trimellitic acid ester include trimethyl trimellitate, triethyl trimellitate, tripropyl trimellitate, tributyl trimellitate, triamyl trimellitate, trihexyl trimellitate, triheptyl trimellitate, tri-n-octyl trimellitate, tri-2-ethylhexyl trimellitate, trinonyl trimellitate, triisononyl trimellitate, tris(decyl) trimellitate, tris(dodecyl) trimellitate, tri(tetradecyl) trimellitate, tris-(C8 to C12 mixed alkyl) trimellitate, tris-(C7 to C9 mixed alkyl) trimellitate, and trilauryl trimellitate. Examples of commercially available products thereof include ADEKACIZER C-8, C-880, C-79, C810, C-9N, and C-10 from ADEKA CORPORATION.

The polyvalent carboxylic acid ester-based plasticizer preferably contains an ether bond. Here, from the viewpoint of flexibility and heat resistance, a polyvalent carboxylic acid ester-based plasticizer that does not contain a polyalkylene oxide structure is preferable. Examples of commercially available products thereof ADEKACIZER RS-107 (specifically, dibutoxyethoxyethyl adipate) manufactured by ADEKA CORPORATION. The above compounds are called adipic acid ether ester-based compound.

Examples of the glycerin-based plasticizer include glycerin monoaceto monolaurate, glycerin diaceto monolaurate, glycerin monoaceto monostearate, glycerin diaceto monooleate, and glycerin monoaceto monomontanate.

Examples of the phosphoric acid ester-based plasticizer include tributyl phosphate, tri-2-ethylhexyl phosphate, trioctyl phosphate, triphenyl phosphate, diphenyl-2-ethylhexyl phosphate, and tricresyl phosphate.

Examples of the epoxy-based plasticizer include epoxy triglyceride consisting of an alkyl epoxy stearate and soybean oil. Examples of the epoxy-based plasticizer also include an epoxy resin that contains bisphenol A and epichlorohydrin as raw materials.

Examples of the polyacrylic acid ester-based plasticizer include a polymer of an acrylic acid alkyl ester. The polyacrylic acid ester-based plasticizer may have functional groups such as an epoxy group and a carboxy group. Examples of commercially available products thereof include ARUFON series manufactured by TOAGOSEI CO., LTD. (for example, non-functional UP series).

Examples of other plasticizers include benzoic acid esters of aliphatic polyols such as neopentyl glycol dibenzoate, diethylene glycol dibenzoate, and triethylene glycol di-2-ethylbutyrate, fatty acid amides such as stearic acid amide, aliphatic carboxylic acid esters such as butyl oleate, oxyacid esters such as methyl acetyl ricinolate and butyl acetyl ricinolate, pentaerythritol, sorbitol, a polyacrylic acid ester, silicone oil, and paraffins.

From the viewpoint of heat resistance and effect of the plasticizer, the molecular weight of the plasticizer is preferably 400 to 10,000, and more preferably 500 to 2,000. In a case where the plasticizer has a molecular weight distribution, it is preferable that the weight-average molecular weight of the plasticizer be within the above range.

The outermost layer may contain one kind of plasticizer or two or more kinds of plasticizers.

The content of the plasticizer with respect to 100 parts by mass of the specific water-absorbent polymer is preferably 1 part by mass to 100 parts by mass, more preferably 5 parts by mass to 70 parts by mass, and even more preferably 10 parts by mass to 50 parts by mass.

The ratio of the total mass of the plasticizer to the total mass of the outermost layer is preferably 1% by mass to 35% by mass, and more preferably 3% by mass to 30% by mass.

From the viewpoint of improving durability, the outermost layer preferably contains a pressure-sensitive adhesive component. The pressure-sensitive adhesive component can make the outermost layer function as a pressure-sensitive adhesive. In a case where the outermost layer functions as a pressure-sensitive adhesive, the film is unlikely to be peel off from an object while being used, and the water stopping properties last for a long time.

Examples of the pressure-sensitive adhesive component include a pressure-sensitive adhesive component contained in the pressure-sensitive adhesive layer which will be described later. The pressure-sensitive adhesive component contained in the outermost layer is preferably polyvinyl alcohol.

The outermost layer may contain one kind of pressure-sensitive adhesive component or two or more kinds of pressure-sensitive adhesive components.

The ratio of the total mass of the pressure-sensitive adhesive component to the total mass of the outermost layer is preferably 1% by mass to 20% by mass.

The thickness of the outermost layer is, for example, 50 μm to 500 μm.

A part of the outermost layer may permeate the permeable layer. In the present disclosure, “the outermost layer permeates the permeable layer” means that the outermost layer has permeated the permeable layer in appearance. In other words, a mixed region where a part of the outermost layer is mixed into the permeable layer is formed. In a case where the outermost layer has permeated the permeable layer, “thickness of the permeable layer” means the thickness of the permeable layer including the mixed region, and “thickness of the outermost layer” means the thickness of the outermost layer excluding the mixed region. That is, the thickness of the mixed region is included in the thickness of the permeable layer. The degree of permeation of the outermost layer into the permeable layer is represented by the ratio of the thickness of the permeable layer permeated by the outermost layer to the total thickness of the permeable layer. The degree of permeation of the outermost layer into the permeable layer is preferably 20% to 90%. In a case where the degree of permeation is 20% to 90%, water is supplied to the outermost layer at a higher rate, which promotes swelling of the outermost layer. As a result, the time required to stop water is shortened. Furthermore, in a case where the specific water-absorbent polymer contained in the outermost layer is crosslinked with or closely attached to the material (for example, the nonwoven fabric) constituting the permeable layer, the gelled specific water-absorbent polymer is unlikely to be eluted, which improves durability.

The manufacturing method of the outermost layer is not limited. The outermost layer is formed, for example, by applying the specific water-absorbent polymer onto the permeable layer. The specific water-absorbent polymer applied onto the permeable layer may be dried as necessary. The specific water-absorbent polymer applied onto the permeable layer may be heated as necessary. The heating treatment can promote the permeation of the outermost layer into the permeable layer. The heating temperature is preferably 50° C. to 100° C.

In the manufacturing method of the outermost layer, a composition containing the specific water-absorbent polymer may be used. The composition containing the specific water-absorbent polymer may contain other components such as a plasticizer, a pressure-sensitive adhesive component, a solvent, an ultraviolet absorber, an antioxidant, a crosslinking agent, a surfactant, a filler, a colorant, a light stabilizer, a thickener, and a polymerization initiator.

Permeable Layer

In an embodiment of the present disclosure, the film includes a permeable layer. The permeable layer is a layer having a function of allowing permeation of water, and preferably has a porous structure. In a case where water permeates the permeable layer, the water permeating the permeable layer moves to the outermost layer, which promotes swelling of the outermost layer.

The water absorption rate of the permeable layer is preferably 0.004 g/mm²/s or more, more preferably 0.008 g/mm²/s or more, and even more preferably 0.05 g/mm²/s or more. In a case where the water absorption rate of the permeable layer is 0.004 g/mm²/s or more, swelling of the outermost layer is very effectively promoted.

The water absorption rate of the permeable layer is measured by the following method. First, the permeable layer is collected from the film. From the collected permeable layer, a sample having a width of 10 mm is prepared. The mass of the sample not yet absorbing water is measured. One end of the sample that is a portion having a width of 10 mm and a length of 1 mm is immersed in water for 10 seconds. The mass of the sample having absorbed water is measured. The water absorption rate is calculated from the following equation. In the following equation, the cross-sectional area immersed in water is 10 mm² (width 10 mm×length 1 mm).

Equation: Water absorption rate (g/mm²/s)=(mass of sample having absorbed water−mass of sample not yet absorbing water)/(cross-sectional area immersed in water)/(time for which sample is immersed in water)

From the viewpoint of water permeability, the permeable layer is preferably a layer containing fibers. Examples of the fibers include cellulose fibers, rayon fibers, polyolefin fibers (for example, polyethylene fibers and polypropylene fibers), polyvinyl chloride fibers, polyester fibers, polyurethane fibers, and polyamide fibers. The permeable layer is preferably a layer containing at least one kind of fibers selected from the group consisting of cellulose fibers, rayon fibers, polyolefin fibers, and polyester fibers, and more preferably a layer containing at least one kind of fibers selected from the group consisting of rayon fibers, polyolefin fibers, and polyester fibers. The permeable layer may contain rayon fibers, polyolefin fibers, and polyester fibers.

From the viewpoint of water permeability, the permeable layer is preferably a nonwoven fabric or paper, and more preferably a nonwoven fabric. Examples of commercially available nonwoven fabrics include TECHNOWIPE RN100-M (NIPPON PAPER CRECIA CO., LTD.).

The width of the permeable layer is preferably smaller than the width of the substrate layer. That is, it is preferable that the permeable layer be provided on a part of the substrate layer without completely covering the substrate layer. It is preferable that the permeable layer be provided so that the permeable layer is located at the center in the width direction of the substrate layer. In a case where the film includes the pressure-sensitive adhesive layer, which will be described later, between the permeable layer and the substrate layer, the width of the permeable layer is preferably smaller than the width of the pressure-sensitive adhesive layer. That is, it is preferable that the permeable layer be provided on a part of the pressure-sensitive adhesive layer without completely covering the pressure-sensitive adhesive layer. It is preferable that the permeable layer be provided so that the permeable layer is located at the center in the width direction of the pressure-sensitive adhesive layer.

The thickness of the permeable layer is, for example, 50 μm to 500 μm.

Substrate Layer

In an embodiment of the present disclosure, the film includes a substrate layer.

Examples of the components of the substrate layer include a resin and a metal. The substrate layer is preferably a substrate layer containing a resin, that is, a resin substrate layer. Examples of the resin include polyolefin, polyester, polyethylene terephthalate (PET), polyethylene naphthalate (PEN), an acrylic resin, polycarbonate (PC), triacetyl cellulose (TAC), a cycloolefin polymer (COP), and an acrylonitrile/butadiene/styrene copolymer resin (ABS resin). From the viewpoint of waterproofness, the substrate layer preferably contains polyethylene, polypropylene, or polyester. The substrate layer may contain one kind of resin or two or more kinds of resins.

It is preferable that the substrate layer have a waterproof function. In a case where the substrate layer has a waterproof function, the film held in a predetermined place improves durability against flooding. In the present disclosure, “waterproof function” means that the leakage amount of water leaking through the substrate layer per hour is 500 g or less in a leak test by filling water at a diameter of 10 mm. The water leakage amount is measured by the following method. First, the substrate layer is collected from the film. A cylindrical tube with a diameter of 10 mm is filled with water to a depth of 100 mm. The substrate layer is attached to the opening of the cylindrical tube, and a lid is put thereon. The cylindrical tube is turned upside down and kept as it is for 1 hour. The amount of water leaking for 1 hour (unit: g) is measured.

The thickness of the substrate layer is, for example, 15 μm to 200 μm.

The substrate layer is preferably an elongated layer. However, the length and width of the substrate layer are not limited. “Length of the substrate layer” means the length of the substrate layer in the longitudinal direction, “width of the substrate layer” means the length of the substrate layer in a direction that is orthogonal to the longitudinal direction and thickness direction of the substrate layer.

Pressure-Sensitive Adhesive Layer

In an embodiment of the present disclosure, the film preferably includes a pressure-sensitive adhesive layer. The pressure-sensitive adhesive layer is preferably disposed between the permeable layer and the substrate layer.

The pressure-sensitive adhesive layer is a layer that functions as a pressure-sensitive adhesive. In the present disclosure, “pressure-sensitive” means that the layer can be stuck to a member (for example, glass) and can be peeled off from the member (for example, glass).

The pressure-sensitive adhesive layer preferably contains a pressure-sensitive adhesive component. Examples of the pressure-sensitive adhesive component include a silicone resin, an acrylic resin, a vinyl resin, polyurethane, a polyamide, a polyester, a polyolefin, and rubber.

Examples of the silicone resin include an addition reaction-type silicone resin, a peroxide curing-type silicone resin, and condensation-type silicone resin.

Examples of the acrylic resin include a homopolymer of an acrylic acid ester compound and a copolymer of an acrylic acid ester compound and other monomers. Examples of the acrylic acid ester compound include methyl (meth)acrylate, ethyl (meth)acrylate, butyl (meth)acrylate, 2-ethylhexyl (meth)acrylate, hydroxyethyl methacrylate, hydroxypropyl methacrylate, dimethylaminoethyl methacrylate, and glycidyl methacrylate. Examples of the aforementioned other monomers include vinyl acetate, (meth)acrylonitrile, (meth)acrylamide, styrene, a methacrylic acid, an acrylic acid, itaconic acid, methylolacrylamide, and maleic acid anhydride.

Examples of the vinyl resin include polyvinyl alcohol and polyvinylpyrrolidone.

Examples of the polyurethane include polyester polyurethane and polycarbonate polyurethane.

Examples of the polyamide include a polyamide obtained by ring-opening polycondensation of undecane lactam (amide 11) and a polyamide obtained by ring-opening polycondensation of lauryl lactam (amide 12).

Examples of the polyester include a polycondensate of a polyvalent carboxylic acid and a polyhydric alcohol. Specifically, examples thereof include polyethylene terephthalate and polybutylene terephthalate.

Examples of the polyolefin include a homopolymer of an olefin and a copolymer of an olefin and other monomers. The olefin is preferably an olefin having 2 to 6 carbon atoms. Examples of the olefin include ethylene, propylene, butene, methylpentene, and hexene. Examples of the copolymer of an olefin and other monomers include an ethylene-vinyl acetate copolymer (EVA), an ethylene-acrylic acid copolymer (EAA), an ethylene-ethyl acrylate copolymer (EEA), and an ethylene-methyl methacrylate copolymer (EMMA).

Examples of the rubber include a styrene/butadiene copolymer (SBR, SBS), a styrene/isoprene copolymer (SIS), an acrylonitrile-butadiene copolymer (NBR), a chloroprene polymer, and an isobutylene/isoprene copolymer (butyl rubber).

The pressure-sensitive adhesive layer may contain one kind of pressure-sensitive adhesive component or two or more kinds of pressure-sensitive adhesive components.

The thickness of the pressure-sensitive adhesive layer is, for example, 10 μm to 500 μm.

The pressure-sensitive adhesive layer is formed, for example, by applying a composition for a pressure-sensitive adhesive layer containing a pressure-sensitive adhesive component on the substrate layer and drying the composition. The composition for a pressure-sensitive adhesive layer may contain other components. Examples of those other components include a solvent, an ultraviolet absorber, an antioxidant, a crosslinking agent, a surfactant, a filler, a colorant, a light stabilizer, a thickener, and a polymerization initiator.

The pressure-sensitive adhesive layer may be a pressure-sensitive adhesive material obtained by peeling off a peelable liner of a double-sided pressure-sensitive adhesive sheet or a double-sided pressure-sensitive adhesive tape. By attaching the pressure-sensitive adhesive material, which is obtained by peeling off a peelable liner of a double-sided pressure-sensitive adhesive sheet or a double-sided pressure-sensitive adhesive tape, onto the substrate, it is possible to form the pressure-sensitive adhesive layer. The double-sided pressure-sensitive adhesive sheet and the double-sided pressure-sensitive adhesive tape may be commercially available products.

The laminate including the substrate layer and the pressure-sensitive adhesive layer may be a commercially available single-sided pressure-sensitive adhesive sheet or single-sided pressure-sensitive adhesive tape.

Structure

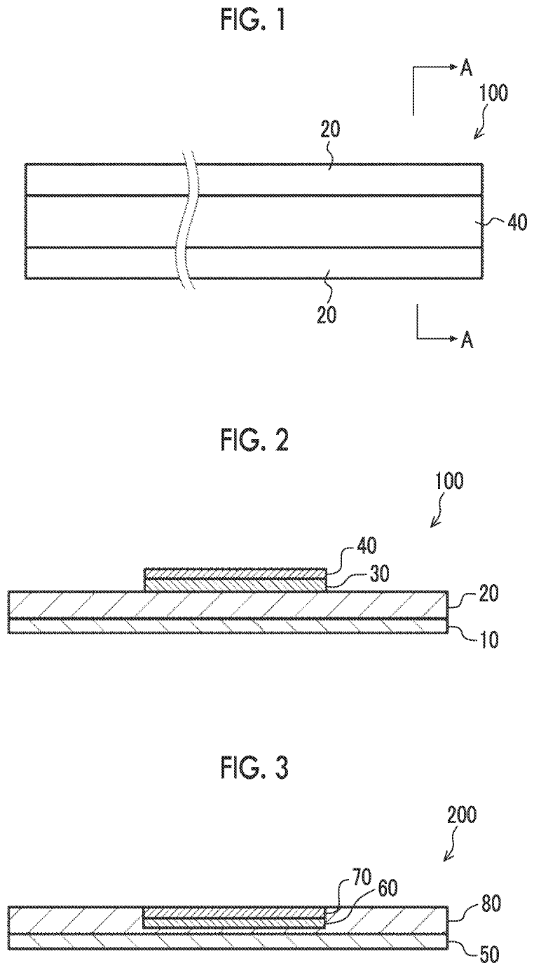

The structure of the film will be described with reference to FIGS. 1 to 3. However, the structure of the film is not limited to the structures shown in FIGS. 1 to 3.

First, FIGS. 1 and 2 will be described. FIG. 1 is a schematic plan view showing the configuration of a film according to an embodiment. FIG. 2 is a cross-sectional view taken along the line A-A in FIG. 1. A film 100 shown in FIGS. 1 and 2 includes a substrate layer 10, a pressure-sensitive adhesive layer 20, a permeable layer 30, and an outermost layer 40 containing the specific water-absorbent polymer in this order.

In the film 100, not only the exposed surface of the outermost layer 40 but also the surface of the outermost layer 40 that faces the permeable layer 30 can come into contact with water. Therefore, with the film 100, it is possible to effectively stop up a water permeating hole due to the outermost layer 40 that can swell over a wide range. For example, in a case where the film 100 is installed on a rough surface, water also enters from a gap between the surface on which the film 100 is installed and the film 100. In addition, sometimes water also enters from both end parts of the film 100 that is perpendicular to the main surface of the film 100. In this way, the water that enters in various directions permeates the permeable layer, which enables the water to be supplied to the outermost layer 40 and enables the outermost layer 40 to swell.

The length of the pressure-sensitive adhesive layer 20 is approximately the same as the length of the substrate layer 10. The width of the pressure-sensitive adhesive layer 20 is approximately the same as the width of the substrate layer 10. The pressure-sensitive adhesive layer 20 completely covers the substrate layer 10.

The width of the permeable layer 30 is smaller than the width of the substrate layer 10 and the width of the pressure-sensitive adhesive layer 20. A part of the surface of the pressure-sensitive adhesive layer 20 facing the permeable layer 30 is exposed. For example, by disposing the outermost layer 40 so that the outermost layer 40 faces a water permeating hole, and pressing the exposed surface of the pressure-sensitive adhesive layer 20 on a member in the vicinity of a gap, it is possible to fix the film 100.

The length of the outermost layer 40 is approximately the same as the length of the permeable layer 30. The width of the outermost layer 40 is approximately the same as the width of the permeable layer 30. The outermost layer 40 completely covers the permeable layer 30.

As shown in FIG. 2, in a cross-sectional view of the film 100, the permeable layer 30 and the outermost layer 40 are in the form of a projection protruding in a direction away from the substrate layer 10. Therefore, swelling of the outermost layer 40 makes it possible to more rapidly close the gap and to stop water in a short time. Furthermore, because the outermost layer 40 forms a projection, it is easy to dispose the film 100 at a position where the outermost layer 40 faces the water permeating hole.

In FIG. 2, for convenience, the boundary between the permeable layer 30 and the outermost layer 40 is clearly illustrated. However, because a part of the outermost layer 40 permeates the permeable layer 30 in some cases, sometimes the boundary between the permeable layer 30 and the outermost layer 40 is unclear in reality.

As described above, in the film 100 shown in FIGS. 1 and 2, the pressure-sensitive adhesive layer 20 is provided on the substrate layer 10. However, not the pressure-sensitive adhesive layer 20 but the permeable layer 30 may be provided on the substrate layer 10. In a case where the permeable layer 30 is provided on the substrate layer 10, for example, using a pressure-sensitive adhesive tape makes it possible to fix the film to a place where water needs to be stopped.

As described above, in the film 100 shown in FIGS. 1 and 2, the length of the permeable layer 30 is approximately the same as the length of the outermost layer 40, and the width of the permeable layer 30 is approximately the same as the width of the outermost layer 40. However, the width of the outermost layer 40 may be smaller than the width of the permeable layer 30. In a case where the width of the outermost layer 40 is smaller than the width of the permeable layer 30, water is easily absorbed into the surface of the outermost layer 40 facing the permeable layer 30, and expansion of the outermost layer 40 is promoted, which makes it possible to stop the water in a short time.

Next, FIG. 3 will be described. FIG. 3 is a schematic cross-sectional view showing the configuration of a film according to another embodiment. A film 200 shown in FIG. 3 includes a substrate layer 50, a permeable layer 60, an outermost layer 70 containing the specific water-absorbent polymer, and a pressure-sensitive adhesive layer 80. Specifically, the film 200 includes the permeable layer 60 and the outermost layer 70 in this order on a part of the substrate layer 50, and includes the pressure-sensitive adhesive layer 80 on a part of the substrate layer 50 that is not covered with the permeable layer 60.

Within one main surface of the film 200, the surface of the outermost layer 70 is flush with the surface of the pressure-sensitive adhesive layer 80. Therefore, it is easy to store the film 200 by rolling up the film.

Examples of the manufacturing method of the film 200 include a first manufacturing method and a second manufacturing method described below.

In the first manufacturing method, first, on a substrate layer, a first pressure-sensitive adhesive layer having the same width as the substrate layer is formed to overlap the substrate layer. A permeable layer having a width smaller than the width of the first pressure-sensitive adhesive layer is attached to the center of the first pressure-sensitive adhesive layer, and an outermost layer is formed on the permeable layer. On a surface of the first pressure-sensitive adhesive layer, the surface not being provided with the permeable layer, a second pressure-sensitive adhesive layer is formed. The second pressure-sensitive adhesive layer can be formed by applying a composition for a pressure-sensitive adhesive layer for forming the second pressure-sensitive adhesive layer in a patterned manner. Examples of the application method include a screen printing method and stripe coating. The height of the second pressure-sensitive adhesive layer is adjusted so that the surface of the second pressure-sensitive adhesive layer is flush with the surface of the outermost layer. Each of the first pressure-sensitive adhesive layer and the second pressure-sensitive adhesive layer may be a pressure-sensitive adhesive material obtained by peeling off a peelable liner of a commercially available double-sided pressure-sensitive adhesive sheet or double-sided pressure-sensitive adhesive tape.

In the second manufacturing method, first, a laminate including a first pressure-sensitive adhesive layer having a width smaller than the width of a substrate layer, a permeable layer, and an outermost layer are laminated in this order, thereby preparing a laminate. The laminate is attached to the center of a substrate layer so that the first pressure-sensitive adhesive layer is in contact with the substrate layer. On a surface of the substrate layer, the surface not being provided with the laminate, a second pressure-sensitive adhesive layer is formed. The second pressure-sensitive adhesive layer can be formed by applying a composition for a pressure-sensitive adhesive layer for forming the second pressure-sensitive adhesive layer in a patterned manner. Examples of the application method include a screen printing method and stripe coating. The height of the second pressure-sensitive adhesive layer is adjusted so that the surface of the second pressure-sensitive adhesive layer is flush with the surface of the outermost layer. Each of the first pressure-sensitive adhesive layer and the second pressure-sensitive adhesive layer may be a pressure-sensitive adhesive material obtained by peeling off a peelable liner of a commercially available double-sided pressure-sensitive adhesive sheet or double-sided pressure-sensitive adhesive tape.

Use

The film may be used, for example, in a water stopping method using a film. In the water stopping method, the film may be used to prevent or reduce water leakage. In the water stopping method, the film may be used to prevent or reduce flooding. The water stopping method preferably includes preparing the film and disposing the film on an object so that the outermost layer of the film and the object face each other. Disposing the film on an object preferably includes attaching the film to the object. The object may be a building. The object may be a window or a door. For example, in a case where the film is disposed on gaps in objects such as a window and a door, even though water reaches the film, the outermost layer expanding by absorbing water can close the gaps and stop water from entering. The film may be used as a water stopping tape.

Water Stopping Tape

Hereinafter, a water stopping tape according to an aspect of the present disclosure will be described.

In an embodiment of the present disclosure, the water stopping tape includes the film described above. Aspects of the film in the water stopping tape are described in the aforementioned section of “Film”. The preferable aspect of the film in the water stopping tape is the same as the preferable aspect of the film described in the aforementioned section of “Film”. The film in the water stopping tape preferably includes a pressure-sensitive adhesive layer.

The form of the water stopping tape is not limited. The water stopping tape may be a water stopping tape wound in a cylindrical shape. The water stopping tape may be a flat plate-shaped water stopping tape. The water stopping tape may be a long water stopping tape. The water stopping tape may be a water stopping tape in the form of polygon such as a quadrangle.

The water stopping tape is used, for example, in various water stopping methods. The water stopping tape is preferably used in the water stopping method described above.

### EXAMPLES

Hereinafter, the present disclosure will be specifically described with reference to examples. However, the present disclosure is not limited to the following examples. What are described in the following examples may be modified as appropriate as long as the modification is within the gist of the present disclosure.

### Example 1

A nonwoven fabric (trade name: TECHNOWIPE RN100-M, NIPPON PAPER CRECIA CO., LTD.) was cut in dimensions of 100 mm×100 mm. A polyurethane (trade name: AQUACALK TWB, SUMITOMO SEIKA CHEMICALS CO., LTD., 2.0 g) was uniformly sprayed on a nonwoven fabric, and then a heating treatment using a hot press machine (MINI TEST PRESS MP-WCL, Toyo Seiki Seisaku-sho, Ltd.) was performed on the nonwoven fabric for 1 minute at 70° C. so that a polymer-containing layer was formed on the surface of the nonwoven fabric. The central portion of the nonwoven fabric with the polymer-containing layer was cut into a rectangle having dimensions of 50 mm×100 mm. A pressure-sensitive adhesive tape (trade name: FIT LIGHT TAPE strong pressure-sensitive adhesive No. 736 Mango, width: 100 mm, SEKISUI CHEMICAL CO., LTD.) was cut in a length of 100 mm. The pressure-sensitive adhesive tape includes a substrate layer containing polyester and a pressure-sensitive adhesive layer. The nonwoven fabric with a polymer-containing layer was attached to the central portion of the pressure-sensitive adhesive tape having dimensions of 100 mm×100 mm. By the above procedure, a film including an outermost layer (polymer-containing layer), a permeable layer, a pressure-sensitive adhesive layer, and a substrate layer in this order was prepared.

### Example 2

A film was prepared according to the method described in Example 1, except that the polyurethane (trade name: AQUACALK TWB, SUMITOMO SEIKA CHEMICALS CO., LTD.) used in Example 1 was changed to a mixture of a polyurethane (2.0 g, trade name: AQUACALK TWB-P, SUMITOMO SEIKA CHEMICALS CO., LTD.) and a plasticizer (0.4 g, trade name: ADEKACIZER RS-1000, ADEKA CORPORATION).

### Example 3

Polyethylene oxide (100 g, 2.0 mmol) having a weight-average molecular weight of 50,000, polypropylene oxide (19.8 g, 5.0 mmol) having a weight-average molecular weight of 4,000, 1,4-butanediol (0.75 g, 8.3 mmol), 4,4′-diphenylmethane diisocyanate (3.62 g, 14.5 mmol), and methyl ethyl ketone (150.0 g) were mixed together at room temperature (specifically, 25° C.). The obtained mixture was heated to 50° C., and NEOSTANN U-600 (0.02 g) was added to the mixture. The mixture was stirred for 10 minutes, then heated to 60° C., and stirred for 6 hours. The obtained reaction solution was added to methanol, thereby obtaining a polyurethane (1).

A film was prepared according to the method described in Example 2, except that the polyurethane (trade name: AQUACALK TWB-P) used in Example 2 was changed to the polyurethane (1).

### Comparative Example 1

Polyethylene oxide (100 g, 2.0 mmol) having a weight-average molecular weight of 50,000, polypropylene oxide (39.5 g, 9.9 mmol) having a weight-average molecular weight of 4,000, 1,4-butanediol (1.28 g, 14.2 mmol), 4,4′-diphenylmethane diisocyanate (5.23 g, 20.9 mmol), and methyl ethyl ketone (150.0 g) were mixed together at room temperature (specifically, 25° C.). The obtained mixture was heated to 50° C., and NEOSTANN U-600 (0.02 g) was added thereto. The mixture was stirred for 10 minutes, then heated to 60° C., and stirred for 6 hours. The obtained reaction solution was added to methanol, thereby obtaining a polyurethane (2).

A film was prepared according to the method described in Example 2, except that the polyurethane (trade name: AQUACALK TWB-P) used in Example 2 was changed to the polyurethane (2).

### Comparative Example 2

A nonwoven fabric (trade name: TECHNOWIPE RN100-M, NIPPON PAPER CRECIA CO., LTD.) was cut in dimensions of 50 mm×100 mm. Crosslinked sodium polyacrylate (1 g, trade name: AQUAPEC MG N40R, SUMITOMO SEIKA CHEMICALS CO., LTD.) was uniformly sprayed on a nonwoven fabric so that a polymer-containing layer was formed on the surface of the nonwoven fabric. The nonwoven fabric was attached to the central portion of a pressure-sensitive adhesive tape according to the method described in Example 1, thereby preparing a film.

### Comparative Example 3

A nonwoven fabric (trade name: TECHNOWIPE RN100-M, NIPPON PAPER CRECIA CO., LTD.) was cut in dimensions of 50 mm×100 mm. Crosslinked sodium polyacrylate (1 g, trade name: SUNFRESH ST-500D, SANYO CHEMICAL, LTD.) was uniformly sprayed on a nonwoven fabric so that a polymer-containing layer was formed on the surface of the nonwoven fabric. The nonwoven fabric with the polymer-containing layer was attached to the central portion of a pressure-sensitive adhesive tape according to the method described in Example 1, thereby preparing a film.

### Comparative Example 4

A nonwoven fabric (trade name: TECHNOWIPE RN100-M, NIPPON PAPER CRECIA CO., LTD.) was cut in dimensions of 50 mm×100 mm. Crosslinked sodium polyacrylate (1 g, trade name: SUNFRESH ST-250, SANYO CHEMICAL, LTD.) was uniformly sprayed on a nonwoven fabric so that a polymer-containing layer was formed on the surface of the nonwoven fabric. The nonwoven fabric with the polymer-containing layer was attached to the central portion of a pressure-sensitive adhesive tape according to the method described in Example 1, thereby preparing a film.

### Comparative Example 5

A nonwoven fabric (trade name: TECHNOWIPE RN100-M, NIPPON PAPER CRECIA CO., LTD.) was cut in dimensions of 50 mm×100 mm. Crosslinked sodium polyacrylate (1 g, trade name: SUNFRESH ST-100, SANYO CHEMICAL, LTD.) was uniformly sprayed on a nonwoven fabric so that a polymer-containing layer was formed on the surface of the nonwoven fabric. The nonwoven fabric with the polymer-containing layer was attached to the central portion of a pressure-sensitive adhesive tape according to the method described in Example 1, thereby preparing a film.

Water Absorbency

A sample (0.1 g) was added to 200 mL of pure water, and the mixture was stirred. After 3 hours of stirring, the mixture was filtered through a wire mesh (product name: TESTING SIEVE, wire diameter: 50 μm, diameter: 150 mmφ, TOKYO SCREEN CO., LTD) having an opening size of 75 μm. The mass of the sample remaining on the wire mesh was measured. The measured mass (unit: g) was divided by 0.1 g, and the obtained value was adopted as water absorbency.

Evaluation: Time Required for Stopping Water

As an experimental water tank, an acryl water tank was prepared which has a hole having a width of 50 mm and a height of 10 mm at the lower portion of the wall surface. The water tank has a width of 300 mm, a depth of 300 mm, and a height of 700 mm. The film was attached to the inner wall surface of the experimental water tank so that the outermost layer of the film faced the hole. Water was poured into the experimental water tank to a height of 500 mm. The time it took to stop water leaking from the hole from when pouring of water into the experimental water tank had finished (that is, the time required for stopping water) was measured. Here, in a case where the water leakage is not stopped, the failure of water stoppage is marked as “N. D.”. The evaluation results are shown in Tables 1 and 2.

Evaluation: Duration of Water Stoppage

In the measurement described in the section of “Evaluation: time required for stopping water” described above, the time it took to stop water leaking again from the hole from when pouring of water into the experimental water tank had finished (that is, duration of water stoppage) was measured. The duration of water stoppage was evaluated according to the following standard. Here, in a case where the water leakage is not stopped, the failure of water stoppage is marked as “N. D.”. The evaluation results are shown in Tables 1 and 2.

A: The duration of water stoppage exceeds 24 hours.

B: The duration of water stoppage is 24 hours or less.

Evaluation: Workability on Curved Surface

The film was attached to the inner bottom surface and the inner wall surface of the water tank described in the section of “Evaluation: time required for stopping water” described above, and the way the water tank and the film come into contact with each other at the corner of the water tank (that is, the portion where the bottom surface and the wall surface cross each other) was visually checked. The angle between the inner bottom surface and the inner wall surface of the water tank is 90°. According to the following standard, the workability on a curved surface was evaluated. The evaluation results are shown in Tables 1 and 2.

A: No gap occurs between the water tank and the film at the corner of the water tank.

B: A gap occurs between the water tank and the film at the corner of the water tank.

Evaluation: Salt Tolerance

Two sheets of nonwoven fabrics with a polymer-containing layer were prepared according to the method described above. One of the nonwoven fabrics was immersed in pure water for 1 hour, and the mass of the nonwoven fabric having been immersed for 1 hour was divided by the mass of the nonwoven fabric not yet being immersed, thereby determining X as a rate of increase in mass of the nonwoven fabric (unit: g/g). The other nonwoven fabric was immersed in a saline solution (salt concentration: 3.5% by mass) for 1 hour, and the mass of the nonwoven fabric having been immersed for 1 hour was divided by the mass of the nonwoven fabric not yet being immersed, thereby determining Y as a rate of increase in mass of the nonwoven fabric (unit: g/g). According to the following standard, the salt tolerance was evaluated. The evaluation results are shown in Tables 1 and 2. The larger the value of “Y/X”, the better the salt tolerance.

0.5≤[Y/X] A:

[Y/X]<0.5 B:

TABLE 1

| | | | Example 1 | Example 2 | Example 3 |
|---|---|---|---|---|---|
| Outermost layer | Specific | Type | AQUACALK | AQUACALK | Polyurethane (1) |
| (polymer- | water- | | TWB | TWB-P | |
| containing | absorbent | Water | 25 | 25 | 14 |
| layer) | polymer | absorbency (g/g) | | | |

| | | | |
|---|---|---|---|
| Plasticizer | — | ADEKACIZER | ADEKACIZER |
| | | RS-1000 | RS-1000 |

| | | | |
|---|---|---|---|
| Permeable layer | TECHNOWIPE | TECHNOWIPE | TECHNOWIPE |
| | RN100-M | RN100-M | RN100-M |
| Substrate layer and | FITLIGHT | FITLIGHT | FITLIGHT |
| pressure-sensitive adhesive layer | TAPE | TAPE | TAPE |
| | No. 736 | No. 736 | No. 736 |
| Time required for stopping water (min) | 10 | 10 | 20 |
| Duration of water stoppage | A | A | A |
| Workability on curved surface | B | A | A |
| Salt tolerance | A | A | A |

TABLE 2

| | | | Comparative | Comparative | Comparative | Comparative | Comparative |
|---|---|---|---|---|---|---|---|
| | | | Example 1 | Example 2 | Example 3 | Example 4 | Example 5 |
| Outermost layer | Comparative | Type | Polyurethane | AQUPEC | SUNFRESH | SUNFRESH | SUNFRESH |
| (polymer-containing | compound | | (2) | MG N40R | ST-500D | ST-250 | ST-100 |
| layer) | | Water | 4 | 300 | 450 | 700 | 1000 |
| | | absorbency | | | | | |
| | | (g/g) | | | | | |

| | | | | | |
|---|---|---|---|---|---|
| Plasticizer | ADEKACIZER | — | — | — | — |
| | RS-1000 | | | | |

| | | | | | |
|---|---|---|---|---|---|
| Permeable layer | TECHNOWIPE | TECHNOWIPE | TECHNOWIPE | TECHNOWIPE | TECHNOWIPE |
| | RN100-M | RN100-M | RN100-M | RN100-M | RN100-M |
| Substrate layer and pressure-sensitive | FITLIGHT | FITLIGHT | FITLIGHT | FITLIGHT | FITLIGHT |
| adhesive layer | TAPE | TAPE | TAPE | TAPE | TAPE |
| | No. 736 | No. 736 | No. 736 | No. 736 | No. 736 |
| Time required for stopping water (min) | N.D. | N.D. | N.D. | N.D. | N.D. |
| Duration of water stoppage | N.D. | N.D. | N.D. | N.D. | N.D. |
| Workability on curved surface | A | A | A | A | A |
| Salt tolerance | A | B | B | B | B |

Tables 1 and 2 show that the water stopping properties last longer in Examples 1 to 3 than in Comparative Examples 1 and 5.

### EXPLANATION OF REFERENCES

10, 50: substrate layer
20, 80: pressure-sensitive adhesive layer
30, 60: permeable layer
40, 70: outermost layer
100, 200: Film

What is claimed is:

1. A film comprising, in the following order:
an outermost layer containing a water-absorbent polymer having a water absorbency of 5 g/g to 100 g/g that is represented by a ratio of a mass of a sample having been immersed in water for 3 hours to a mass of the sample not yet being immersed in water;
a permeable layer; and
a substrate layer.

2. The film according to claim 1,
wherein the water-absorbent polymer includes a polyurethane.

3. The film according to claim 2,
wherein the polyurethane is a polyurethane obtained by reacting a polyalkylene oxide, a diol having a molecular weight of 500 or less, and a diisocyanate.

4. The film according to claim 3,
wherein the polyalkylene oxide is at least one kind of compound selected from the group consisting of polyethylene oxide and polypropylene oxide.

5. The film according to claim 3,
wherein the diol is 1,4-butanediol.

6. The film according to claim 4,
wherein the diol is 1,4-butanediol.

7. The film according to claim 3,
wherein the diisocyanate is 4,4′-diphenylmethane diisocyanate.

8. The film according to claim 4,
wherein the diisocyanate is 4,4′-diphenylmethane diisocyanate.

9. The film according to claim 5,
wherein the diisocyanate is 4,4′-diphenylmethane diisocyanate.

10. The film according to claim 1,
wherein the outermost layer contains a plasticizer.

11. The film according to claim 2,
wherein the outermost layer contains a plasticizer.

12. The film according to claim 3,
wherein the outermost layer contains a plasticizer.

13. The film according to claim 4,
wherein the outermost layer contains a plasticizer.

14. The film according to claim 5,
wherein the outermost layer contains a plasticizer.

15. The film according to claim 6,
wherein the outermost layer contains a plasticizer.

16. A water stopping tape comprising:
the film according to claim 1.

17. A water stopping tape comprising:
the film according to claim 2.

18. A water stopping tape comprising:
the film according to claim 3.

19. A water stopping tape comprising:
the film according to claim 4, wherein the diol is 1,4-butanediol and the diisocyanate is 4,4′-diphenylmethane diisocyanate.

20. The water stopping tape according to claim 19,
wherein the outermost layer contains a plasticizer.
